(19) United States
(12) Patent Application Publication
(10) Pub. No.: US 2004/0259530 A1
(43) Pub. Date: Dec. 23, 2004

(54) Communication apparatus

(75) Inventors: Shuichiro Ishizawa, Saitama-ken (JP); Masaki Kinoshita, Nagano-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 10/869,956

(22) Filed: Jun. 18, 2004

(30) Foreign Application Priority Data
Jun. 18, 2003 (JP) 2003-173317

(51) Int. Cl. H04M 3/16

(52) U.S. Cl. 455/411; 455/410

(57) ABSTRACT

Mobile phone 1 is provided with personal authentication device 13 arranged on outer side portion 11 of mobile phone 1 when folded. When finger F touches a predetermined surface of personal authentication device 13 with mobile phone 1 folded, personal authentication device 13 starts authentication as to whether or not a fingerprint of finger F is consistent with one of its registered fingerprints. Such authentication can be easily carried out with personal authentication device 13 even though mobile phone 1 remains folded and no keys on operation panel 7 are manipulated. Thus, it improves security for information and data stored in a memory of mobile phone 1.

### FIELD OF THE INVENTION

This invention generally relates to a communication apparatus and, more particularly, to a communication apparatus with a personal authentication device.

This application is based upon and claims the benefit of priority from the prior Japanese Patent Application No. 2003-173317, filed on Jun. 18, 2003, the entire contents of which are incorporated herein by reference.

### BACKGROUND OF THE INVENTION

Conventionally, a liquid crystal display integrated mobile phone is available as a convenient telecommunication apparatus. Such a mobile phone, however, is not provided with a useful personal authentication device that can identify and confirm pre-registered persons. Thus, it may have a problem from a viewpoint of information security.

Usually, identification software is installed in the mobile phone to restrict its users to those who register secret ID numbers in the mobile phone. In such cases, the users input the secret ID number to enable the mobile phone to operate. It is feared, however, that other people than the registered users can easily illegally operate the mobile phone if he or she knows the secret numbers. Further, it is troublesome to input the secret number to the mobile phone beforehand.

Japanese Unexamined Patent Publication 2002-330202 has recently disclosed in pages 3 through 5 with reference to FIG. 1 that a mobile phone of this kind includes a fingerprint sensor as a personal authentication device. The fingerprint sensor is arranged in the central portion of an operation panel provided on the front surface of a housing of the mobile phone. When he or she presses the thumb of his or her dominant hand on the fingerprint sensor, it detects user's thumbprint, compares it with the registered fingerprints and performs an authentication. Thus the mobile phone is not enabled to operate unless the thumbprint coincides with the registered fingerprint.

It is not easy, however, to use the fingerprint sensor installed in a folding type mobile phone with the same arrangement as mentioned above because of an additional security function: the fingerprint sensor is not enabled to operate unless a folding state of the mobile phone is released or the mobile phone is in an extended state.

Further, where the operation panel of the mobile phone is covered with a slidable flat lid, the operation panel is not operative except for after sliding the lid to uncover the operation panel. In addition, the fingerprint sensor is configured to be ready for personal authentication whenever the mobile phone is turned on. In other words, the fingerprint sensor of the mobile phone consumes electric power as long as the mobile phone is turned on even if the mobile phone does not transmit or receive any information.

### SUMMARY OF THE INVENTION

Accordingly, the present invention is for solving the problems set forth above and provides a communication apparatus capable of easily using a fingerprint sensor without consuming significant electric power for personal authentication.

The first aspect of the present invention is directed to a communication apparatus provided with a housing arranged for a display unit, an operation unit and a pivoting unit about which said display unit is overlapped with said operation unit, and an authentication device for authenticating an operator, wherein the authentication device is disposed on an outer portion of the housing in a state that the display unit and the operation unit are overlapped or folded about the pivoting unit and the authentication device cannot release the display unit from being overlapped with the operation unit unless the authentication device identifies an authorized operator.

Since the authentication device of the communication apparatus can be configured to authenticate operators without the release of a predetermined state of the housing, the communication apparatus is easily used.

The second aspect of the present invention is directed to a communication apparatus provided with a housing arranged for a communication unit, a personal authentication device disposed on the housing, and switches that turn the authentication device on to check operator's thumb print for authentication when the thumb pushes the switches.

Since the authentication device is not enabled to carry out personal authentication unless the switches turn it on, the authentication device does not unnecessarily consume electronic power for authentication.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a schematic perspective view of a communication apparatus according to the first embodiment of the present invention;

FIG. 2 is a partial perspective view of an unfolded state of the communication apparatus shown in FIG. 1;

FIG. 3 is a schematic perspective view of a communication apparatus according to the second embodiment of the present invention;

FIG. 4 is a schematic perspective view of a communication apparatus according to the third embodiment of the present invention;

FIG. 5 is a schematic perspective view of switches used for the present invention;

FIG. 6 is a schematic perspective view of an operative state of an authentication device of the present invention; and

FIG. 7 is a flow chart in response to operations of the communication apparatus according to the present invention.

### DESCRIPTION OF THE EMBODIMENTS

Embodiments of the present invention will be explained below with reference to the attached drawings. It should be noted that the present invention is not limited to the embodiments but covers their equivalents. Throughout the attached drawings, similar or same reference numerals show similar, equivalent or same components.

### First Embodiment

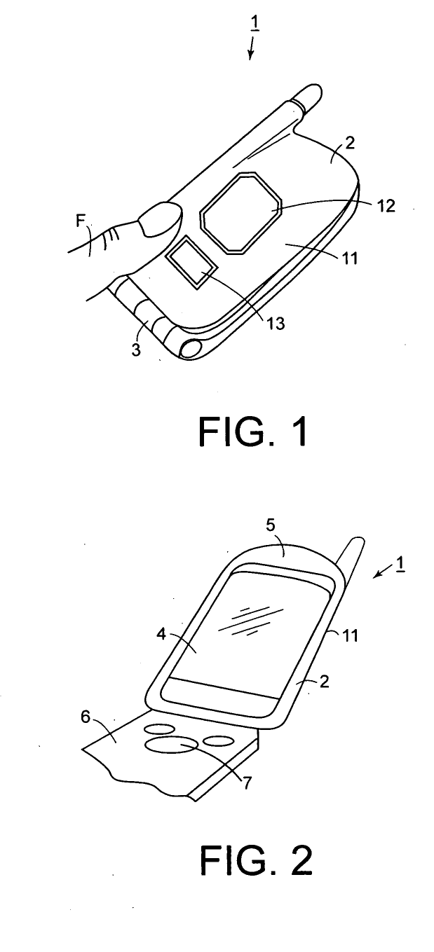

The first embodiment of the present invention will be described with reference to FIGS. 1 and 2. Communication apparatus 1 is a folding type mobile phone integrated with a liquid crystal display unit as shown in FIGS. 1 and 2. Mobile phone 1 is provided with housing 2 that is a narrow, rectangular, flat, main body. Housing 2 includes a communication unit (not shown) capable of transmitting and receiving information in its interior.

Housing 2 is connected to pivoting unit 3 provided at an edge portion of folded mobile phone 1 so that housing 2 can be rotationally folded in two about the rotation axis extending along the edge portion.

When mobile phone 1 is folded, two main interior surfaces of mobile phone 1 face or contact each other. As shown in FIG. 2, the first display means of rectangular liquid crystal main display unit 4 is integrally disposed on one of the main interior surfaces of housing 2 as a main display unit. Main display unit 4 is provided in a central portion of flat panel 5 on an upper side of pivoting unit 3 along longitudinal inner surface on one side of housing 2. Main display unit 4 is a display unit to display images, characters or the like.

Operation panel 7 is provided in flat panel 6 on a lower side of pivoting unit 3 along longitudinal inner surface on another side of housing 2. Operations of keys on operation panel 7 enable an operator to carry out communication.

As shown in FIG. 1, approximately rectangular sub-display unit 12 is arranged on outer side portion 11 reversed to the inner surface of housing 2. Outer side portion 11 always faces the outer side whenever housing is folded. Sub-display unit 12 is disposed on the side reversed to flat panel 5 where main display unit 4 is provided. Sub-display unit 12 is provided in outer side portion 11 on the upper side of pivoting unit 3 along a longitudinal direction of the one side of housing 2. Sub-display unit 12 is another display unit to display images different from those displayed by main display unit 4.

Further, personal authentication device 13 with a rectangular access window is also provided in outer side portion 11 of housing 2. When an operator puts finger F on a personal authentication device 13, personal authentication device 13 identifies an operator as to whether his or her fingerprint is already registered. If that is the case, a control unit (not shown) enables the operator to manipulate the keys of operation panel 7.

Personal authentication device 13 may be provided in some other place on outer side portion 11 of housing 2 than sub-display units 12. In other words, as shown in FIG. 1, personal authentication device 13 is arranged at a central position along a latitudinal direction of outer side portion 11 below sub-display unit 12. Personal authentication device 13 is of a size large enough to detect at least a portion of a fingerprint of operator's finger F.

Operations of the first embodiment will be explained below. At first, mobile phone 1 is ready to operate but folded while the keys on operation panel 7 are set to be inoperative. In these situations, if an operator puts his or her finger F on the access window, personal authentication device 13 detects his or her fingerprint. If personal authentication device 13 determines that the fingerprint is consistent with one of the registered fingerprints, the control unit enables him or her to manipulate the keys of operation panel 7 when mobile phone 1 is unfolded and thereby use mobile phone 1. If personal authentication device 13 determines, however, that the fingerprint is not consistent with any one of the registered fingerprints, the control unit does not enable him or her to manipulate the keys of operation panel 7 and maintains them to be unusable even when mobile phone 1 is unfolded.

As described above, personal authentication device 13 can identify an operator by means of his or her fingerprint as to whether he or she is an authorized person when he or she only puts finger F on the access window of personal authentication device 13 with mobile phone 1 folded.

Thus, the operator is not required to unfold mobile phone 1 or to manipulate the keys of operation panel 7 many times for personal authentication. The first embodiment of the present invention can easily improve securities of data stored in a memory of mobile phone 1.

### Second Embodiment

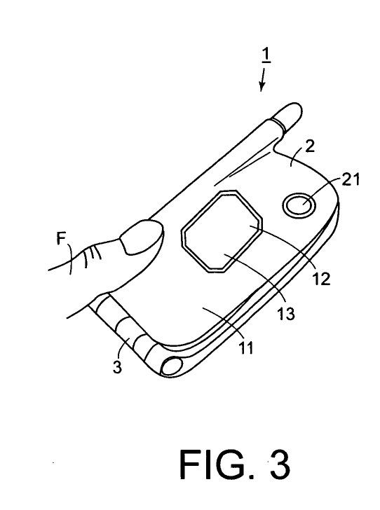

Although personal authentication device 13 of the first embodiment is arranged below sub-display unit 12 on outer side portion 11 of mobile phone 1, as shown in FIG. 3, personal authentication device 13 of the second embodiment can be provided on sub-display unit 12 for the common use of both authentication and display. Thus, no further space is necessary only for personal authentication device 13 on outer side portion 11 of mobile phone 1, so that spaces which would otherwise be used for other components such as a digital camera 21 do not need to be assigned to personal authentication device 13. The degree of design for mobile phone 1 is improved, accordingly.

### Third Embodiment

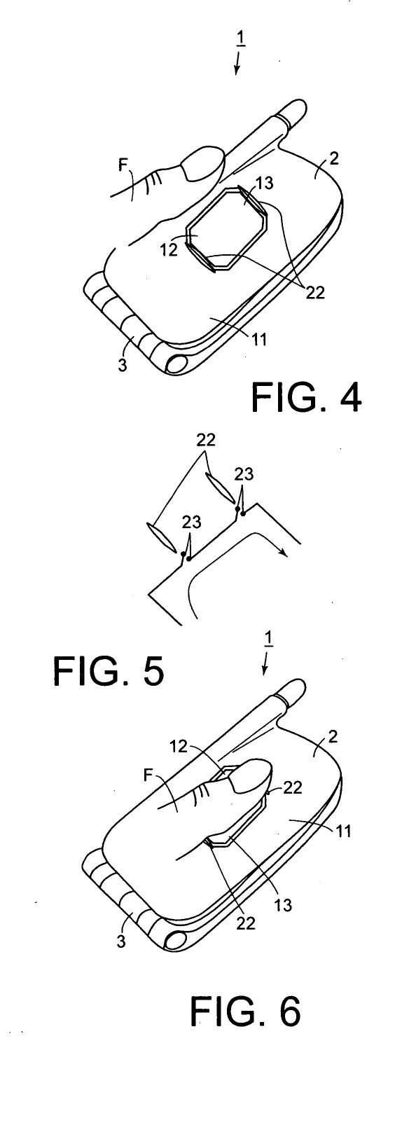

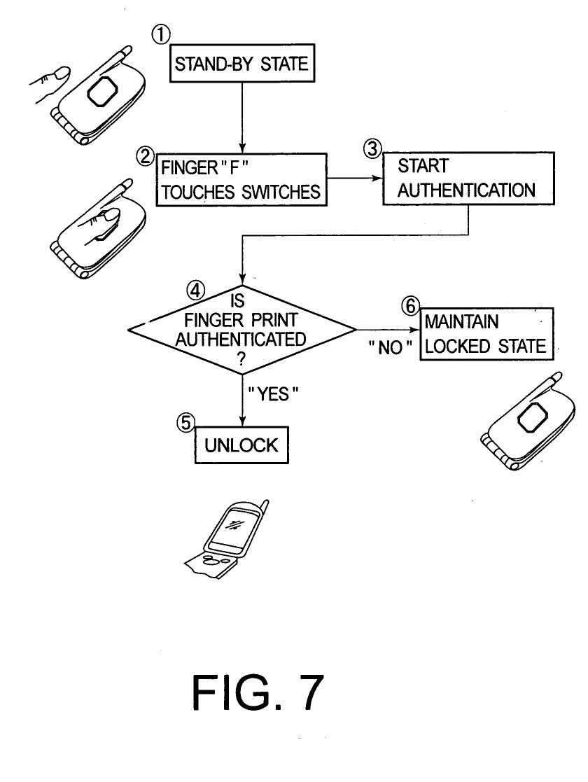

The third embodiment of the present invention will be explained with reference to FIGS. 4 through 7. Mobile phone 1 is basically the same as in FIG. 3 but is provided with switches 22 on upper and lower opposite sides for personal authentication device 13 commonly disposed on sub-display unit 12. Switches 22 are arranged to turn on personal authentication device 13 as shown in FIG. 5 when an operator puts his or her finger F on personal authentication device 13 and finger F touches switches 22 as shown in FIG. 6. Both switches 22 arranged on upper and lower sides of personal authentication device 13 are strips in shape and nearly equal in length to each other.

When the operator touches switches 22 of personal authentication device 13 with finger F and both switches 22 turn on, personal authentication device 13, which has been standing by to save power, turns on and starts authentication of a fingerprint of finger F.

A mechanical lock unit, not shown, is provided to lock mobile phone 1 when flat panels 5 and 6 of housing 2 are rotated about pivoting unit 3 to fold mobile phone 1. Lock and release operations of the mechanical lock unit is controlled by a controller. Only when the fingerprint coincides with one of the fingerprints registered in the memory of mobile phone 1, the controller unlocks the mechanical lock unit to release housing 2 from being folded.

Operations of the third embodiment will be described below with reference to FIGS. 4 through 7. At first, mobile phone 1 is folded and personal authentication device 13 stands by. An operator touches personal authentication device 13 of mobile phone 1 with finger F (Step \mathring{1}). When finger F pushes both switches 22 at the same time (Step \mathring{2}), switches 22 turn on contact members 23 (Step \mathring{3}). Thus, personal authentication device 13 is enabled to start the authentication (Step \mathring{4}). When personal authentication device 13 determines that the fingerprint of finger F is consistent with one of the registered fingerprints, the controller unlocks the mechanical lock unit so that housing 2 can be released from being folded (Step \mathring{5}). When personal authentication device 13 determines that the fingerprint of finger F is not consistent with any one of the registered fingerprints, the controller does not unlock the mechanical lock unit so that housing 2 remains folded (Step \mathring{6}).

As described above, according to the third embodiment of the present invention, an operator touches personal authentication device 13 with his or her finger F so that personal authentication device 13 can determine whether or not a fingerprint of finger F is one of the fingerprints registered in personal authentication device 13. Thus, the third embodiment of the present invention has substantially the same operations and advantages as in the second embodiment.

Even though an operator touches personal authentication device 13 with his or her finger F, personal authentication device 13 is not enabled to start the authentication unless finger F turns on switches 22. A position of finger F and pressure on personal authentication device 13 with finger F are designed to suitably operate personal authentication device 13. Thus, its touch position and area are less dispersed so that personal authentication device 13 can precisely authenticate operators by their fingerprints and easily enable the controller to perform control functions.

As described above, personal authentication device 13 is not released from its stand-by state or does not start the authentication operations by fingerprints unless the touch on personal authentication device 13 with finger F turns on switches 22. Thus, personal authentication device 13 consumes less power.

Further, the mechanical lock unit is not unlocked or does not release housing 2 from being folded unless the fingerprint of finger F is consistent with one of the registered fingerprints. Thus, since the keys on operation panel 7 of housing 2 cannot be manipulated if housing 2 remains folded, the security of information and data stored in the memory of mobile phone 1 is improved easily and securely.

Although the third embodiment of the present invention is provided with switches on upper and lower sides of personal authentication device 13, two or more separate switches may be provided at the circumference of personal authentication device 13.

A fingerprint of finger F is utilized for personal authentication device 13 but configurations or portions of finger F placed on personal authentication device 13 may also be used in place of the fingerprint.

Although mobile phone 1 is not limited to such a folded type one as described, other mobile phones may be used, e.g., operation panel 7 of mobile phone 1 may be covered with a lid capable of opening and closing. In this case, personal authentication device 13 is arranged on outer portion of housing 2 with the lid covered to perform substantially the same operations and effect as of the third embodiment of the present invention.

According to the present invention, personal authentication can be carried out with a movable component locked so that it is easily used. Since a touch with a finger enables switches and a personal authentication device to turn on to identify an operator by his or her fingerprint or finger configuration, the authentication consumes less power.

What is claimed is:

1. A communication apparatus comprising:
a housing having a display unit, an operation unit and a pivoting unit about which said display unit is overlapped with said operation unit; and
an authentication device for authenticating an operator, said authentication device being arranged on an outer portion of said housing in a state that said display unit and said operation unit are overlapped about said pivoting unit.

2. A communication apparatus according to claim 1, further comprising;
a sub-display unit arranged on said outer portion of said housing, said sub-display unit being placed differently from said authentication device.

3. A communication apparatus according to claim 1, further comprising;
a sub-display unit arranged on said outer portion of said housing,
wherein said sub-display unit and said authentication device are placed commonly.

4. A communication apparatus according to claim 1, wherein said authentication device cannot release said display unit from being overlapped with said operation unit unless said authentication device identifies an authorized operator.

5. A communication apparatus comprising:
a housing having a display unit, an operation unit and a pivoting unit about which said display unit is folded with said operation unit; and
an authentication device for authenticating an operator, said authentication device being arranged on an outer portion of said housing in a state that said display unit and said operation unit are folded about said pivoting unit.

6. A communication apparatus according to claim 5, further comprising;
a sub-display unit arranged on said outer portion of said housing, said sub-display unit being placed differently from said authentication device.

7. A communication apparatus according to claim 5, further comprising;
a sub-display unit arranged on said outer portion of said housing,
wherein said sub-display unit and said authentication device are placed commonly.

8. A communication apparatus according to claim 5, wherein said authentication device cannot release said display unit from being folded with said operation unit unless said authentication device identifies an authorized operator.
